(19) United States
(12) Patent Application Publication
(10) Pub. No.: US 2018/0310534 A1
(43) Pub. Date: Nov. 1, 2018

(54) LIVE ORGANISM STORAGE SYSTEM

(71) Applicant: SHELL, LLC, Fishing Creek, MD (US)

(72) Inventors: Ricky Fitzhugh, Fishing Creek, MD (US); Johnny Shockley, Fishing Creek, MD (US)

(21) Appl. No.: 15/965,448

(22) Filed: Apr. 27, 2018

Related U.S. Application Data
(60) Provisional application No. 62/597,596, filed on Dec. 12, 2017.
(60) Provisional application No. 62/491,772, filed on Apr. 28, 2017.

(51) Int. Cl. A01K 63/04; A01K 61/54; A01K 63/00; C02F 9/00

(52) U.S. Cl. CPC A01K 63/045; A01K 63/042; A01K 63/065; A01K 63/003; C02F 9/00; A01K 61/54

(57) ABSTRACT

A live organism storage system includes a holding tank configured to hold water and a plurality of live organisms, a water purifier in fluid communication with the holding tank and configured to purify water flowing therethrough, a fractionator in fluid communication with the holding tank, the fractionator configured to gather and remove protein and waste from water flowing therethrough, an oxygenator in fluid communication with the holding tank to increase oxygen content of water flowing therethrough, and a filter in fluid communication with the holding tank and configured to filter water flowing therethrough. The live organism storage system is a closed loop system.

### CROSS-REFERENCE TO RELATED APPLICATIONS

This application claims priority to and the benefit of U.S. Provisional Application No. 62/597,596, filed Dec. 12, 2017, and U.S. Provisional Application No. 62/491,772, filed Apr. 28, 2017, the entire content of each being herein incorporated by reference in their entirety.

### BACKGROUND

### 1. Field

The present disclosure relates to live organism storage systems.

### 2. Description of Related Art

Certain organisms are handled and processed while alive. Oysters, for example, are harvested and processed for shipping while alive. Existing handling/storage methods and systems can be unsanitary and can lead to the spread of disease, as well as a poor tasting product.

Such conventional methods and systems have generally been considered satisfactory for their intended purpose. However, there is still a need in the art for improved live organism storage systems. The present disclosure provides a solution for this need.

### SUMMARY

A live organism (e.g., shellfish such as oysters) storage system includes a holding tank configured to hold water and a plurality of live organisms, a water purifier in fluid communication with the holding tank and configured to purify water flowing therethrough, a fractionator in fluid communication with the holding tank, the fractionator configured to gather and remove protein and waste from water flowing therethrough, an oxygenator in fluid communication with the holding tank to increase oxygen content of water flowing therethrough, and a filter in fluid communication with the holding tank and configured to filter water flowing therethrough. The live organism storage system is a closed loop system.

The water purifier can include an ultraviolet (UV) water treatment system. The UV treatment system can include a horizontally mounted channel mounted over the holding tank to a wall of the holding tank. Any suitable water purification system is contemplated herein.

The fractionator can include a vertical chamber configured to fractionate water flowing therethrough. Any other suitable fractionator is contemplated herein.

The filter can include a bio filter. The bio filter can include a chamber with biological material disposed therein. The biological material can include oysters and/or oyster shells. The filter can be configured to remove nitrogen and/or depurate waste. Any suitable filter is contemplated herein.

In certain embodiments, at least one of the water purifier, the fractionator, the oxygenator, or the filter can be in direct two-way fluidic communication with the holding tank. In certain embodiments, any suitable combination(s) of the holding tank, the water purifier, the fractionator, the oxygenator, and the filter are connected in fluidic series. For example, in certain embodiments, the holding tank, the water purifier, the fractionator, the oxygenator, and the filter are all connected in fluidic series in a series order, e.g., such that a single closed loop is formed.

In accordance with at least one aspect of this disclosure, a method includes providing flavored salt to water in a live organism storage system to cause the live organism to uptake a flavor. The live organism storage system can be an oyster storage system. In certain embodiments, providing the flavored salt includes adding flavored salt to the holding tank of the above described system.

In accordance with at least one aspect of this disclosure, an embodiment of a live organism storage system can include a cascading holding tank configured to hold water and a plurality of live organisms, a water purifier in fluid communication with the holding tank and configured to purify water flowing therethrough, a fractionator in fluid communication with the holding tank, the fractionator configured to gather and remove protein and waste from water flowing therethrough, and a filter in fluid communication with the holding tank and configured to filter water flowing therethrough. The live organism storage system is a closed loop system.

In certain embodiments, the water purifier can be a bio filter and the filter can be a UV water treatment system. The fractionator can be configured to extract unwanted proteins from water circulating through the system, e.g., by bombarding the water with fine air bubbles produced by an air diffuser in a reaction chamber, and accruing a foam head that forms at a top of the fractionator in a collection cup, and to allow removal of the foam head from the collection cup through a fractionator drain.

In certain embodiments, the bio filter can include a bottom manifold including a water inlet and a drain, each having a valve such that when the drain valve is closed and the water inlet valve is open, water can fill the bio filter in an upward direction, a water outlet above the bottom manifold to allow water to drain when suitably high, and one or more stages of filtration disposed between the bottom manifold and the water outlet. In certain embodiments, the UV water treatment system can include a tubular UV water filter defining a tube shaped cavity. The UV filter can have three UV bulbs (or any other suitable amount) disposed therein, e.g., parallel with a long axis of the tube shaped cavity and extending at least partially down a length of the tube shaped cavity. The UV bulbs can be positioned 120 degrees apart from each other relative to a circumference of the water treatment system.

In certain embodiments, the UV water filter can include a stator mixer disposed within the tube shaped cavity and configured to mix water flowing to the UV bulbs. The UV water filter can include and a bulb stabilizer configured to hold the bulbs at an end thereof within the tube shaped cavity.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a system in accordance with this disclosure;

FIG. 2 is a perspective view of an embodiment of a water purifier in accordance with this disclosure;

FIG. 3 is a perspective view of an embodiment of a fractionator in accordance with this disclosure;

FIG. 4 is a perspective view of an embodiment of an oxygenator in accordance with this disclosure;

FIG. 5 is a perspective view of an embodiment of a filter in accordance with this disclosure;

FIG. 6 is a schematic view of an embodiment of a system in accordance with this disclosure;

FIG. 7 is a schematic view of an embodiment of a system in accordance with this disclosure;

FIG. 8 is a schematic view of embodiments of a fractionator, a bio filter, and UV filter in accordance with this disclosure;

FIG. 9 is a schematic view of an embodiment of a system in accordance with this disclosure, showing certain example placement and dimensions of various portions of the system;

FIG. 10 is a schematic view of another embodiment of a system in accordance with this disclosure;

FIG. 11 is schematic flow diagram of the system of FIG. 10;

FIG. 12 is a schematic diagram of an embodiment of piping of the system of FIG. 11, showing the system operating in a filtration loop (e.g., normal operation);

FIG. 13 is a schematic diagram of an embodiment of piping of the system of FIG. 11, showing the system operating in a UV only loop;

FIG. 14 is a schematic diagram of an embodiment of piping of the system of FIG. 11, showing the system operating in a drain state;

FIG. 15 shows a perspective view and front view of an embodiment of a cascade live organism tank;

FIG. 16 shows a schematic view side and cross-section view of an embodiment of a cascade live organism tank, showing flow through the cascade tank;

FIG. 17 shows a cross-sectional schematic view of an embodiment of a fractionator in accordance with this disclosure;

FIG. 18 is cross-sectional schematic view of an embodiment of a bio filter in accordance with this disclosure;

FIG. 19 is a cross-sectional schematic view of an embodiment of a UV filter in accordance with this disclosure;

FIG. 20 is a perspective view of the UV filter of FIG. 19; and

FIG. 21 shows a cross-sectional schematic view of the UV filter of FIG. 19, showing an embodiment of approximate relative dimensions and position of UV bulbs relative to the casing of the UV filter, as well as UV dosage to water within the filter (e.g., as shown lighter is higher dosage).

### DETAILED DESCRIPTION

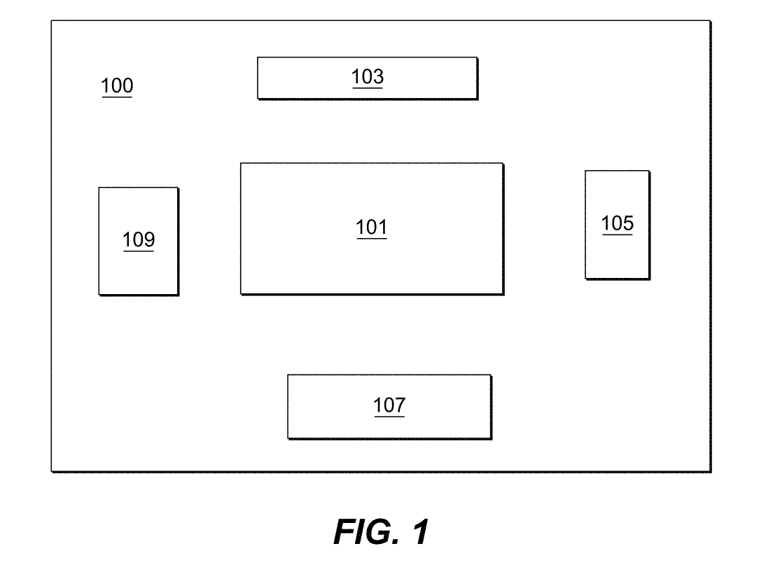

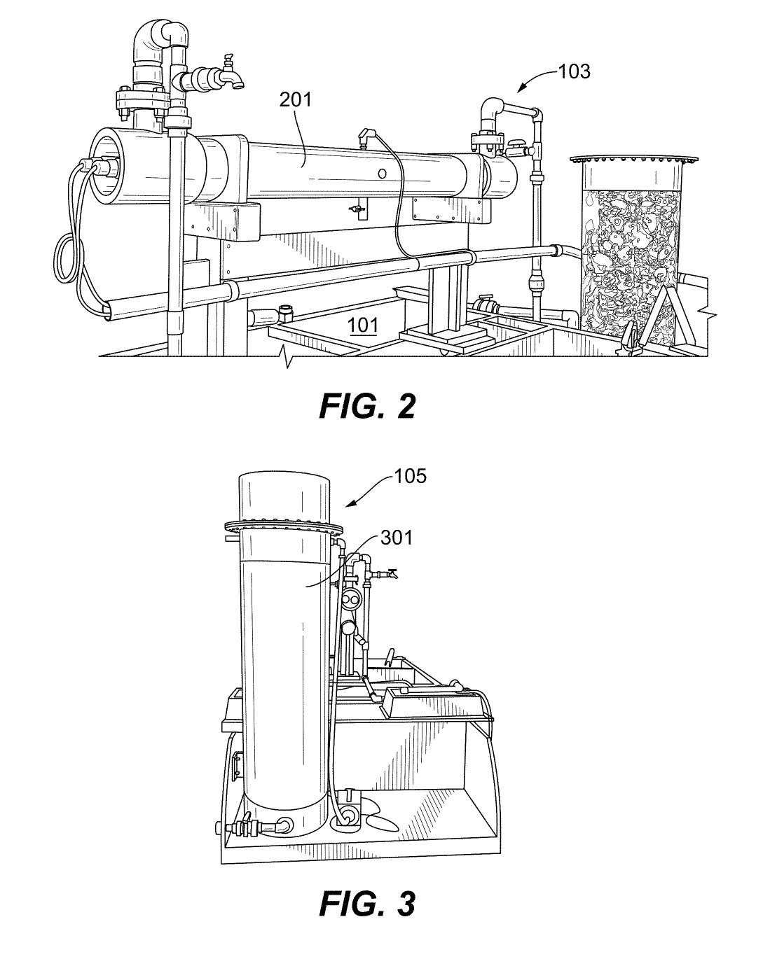

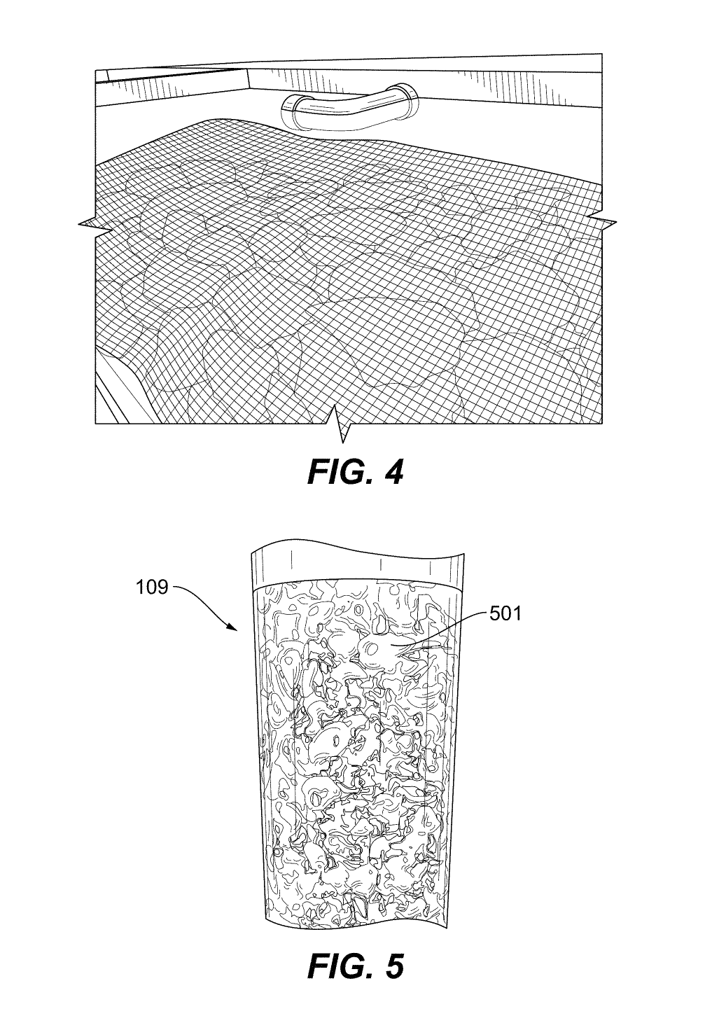

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2-21. The systems and methods described herein can be used to hold and keep fresh live organisms (e.g., oysters). Embodiments can also allow customization of flavor of such live organisms.

Referring to FIG. 1, a live organism (e.g., shellfish such as oysters) storage system 100 includes a holding tank 101 configured to hold water (e.g., salt water) and a plurality of live organisms. For example, the system 100 can be used for oysters or any other suitable live organism, e.g., those meant for human consumption.

The system 100 can include a water purifier 103 in fluid communication with the holding tank 101. The water purifier 103 can be configured to purify water flowing therethrough. Referring additionally to FIG. 2, in certain embodiments, the water purifier 103 can include an ultraviolet (UV) water treatment system as appreciated by those having ordinary skill in the art. The UV treatment system can include a horizontally mounted channel 201 mounted over the holding tank 101 to a wall of the holding tank. The water inside this channel 201 can be exposed to radiation to kill microbes, for example. Any other suitable water purification system(s) 103 is contemplated herein.

The system 100 can include a fractionator 105 in fluid communication with the holding tank 101. The fractionator 105 is configured to gather and remove protein and waste from water flowing therethrough. Referring additionally to FIG. 3, the fractionator 105 can include a vertical chamber 301 configured to fractionate water flowing therethrough. Any other suitable fractionator 105 is contemplated herein.

The protein fractionator or protein skimmer utilizes the intrinsic charge associated with proteins and amino acids to remove them from the system. A large number of very small bubbles are introduced into the main body of the skimmer through a Venturi effect. The large water/air interface allows for the collection of these proteins on the surface of the bubble until it reaches its saturation point. The bubbles then travel to the top of the water column in the vessel. Water is begins to drain at this point and the bubbles become denser. This is what creates the foam that is them removed at the top of vessel that is drained and discarded separately from the water remaining in the tank.

The system 100 can include an oxygenator 107 in fluid communication with the holding tank 101 to increase oxygen content of water flowing therethrough. The oxygen introduced into the system happens at two locations. Firstly, the Venturi injector located on the protein skimmer infuses oxygen into the water by flowing water through a constricted space which increases the velocity and creates a drop in pressure. This constriction occurs over a section of pipe that is exposed to air. As the velocity of the water increases and the pressure drops, it simultaneously pulls air through the exposed section of pipe as the air moves across the pressure gradient that was created by the Venturi system. Secondly, air is infused into the water by spray nozzles at the surface meant to control the foam that collects on the surface. The agitation of the water's surface infuses air bubbles into the water. Any suitable oxygenation system for increasing oxygen content in the water is contemplated herein.

The system 100 can include a filter 109 in fluid communication with the holding tank and configured to filter water flowing therethrough. In certain embodiments, referring additionally to FIG. 5, the filter 109 can include a bio filter for example. The filter can include a chamber 501 with biological material disposed therein. The biological material can include oysters and/or oyster shells, for example. The Biological filter is meant to provide adequate surface area for the purpose of increasing the amount of bacteria. The bacteria that are found in the biological filter are essential to any marine environment and help cycle nitrogen through the system. Oysters release waste into the water in the form of ammonia. High concentrations of ammonia are harmful to any living organism, however, the bacteria found in the filter convert the ammonia into nitrites and then into nitrates. The bacteria fixing the nitrogen in the biological filter are not harmful to the oysters or the consumer. The filter 109 can be configured to remove nitrogen and/or depurate waste. Any suitable filter 109 is contemplated herein.

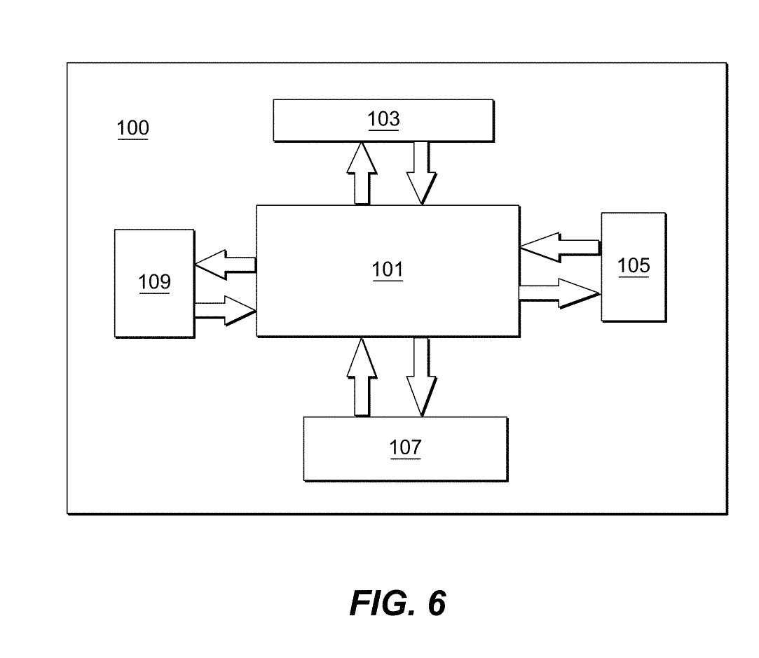

As shown, the live organism storage system 100 is a closed loop system such that the same water circulates throughout all components (e.g., using any suitable pumping mechanism, not shown), e.g., continuously for example. In certain embodiments, one or more of the water purifier 103, the fractionator 105, the oxygenator 107, or the filter 109 can be in direct two-way fluidic communication with the holding tank 101, e.g., as shown in FIG. 6.

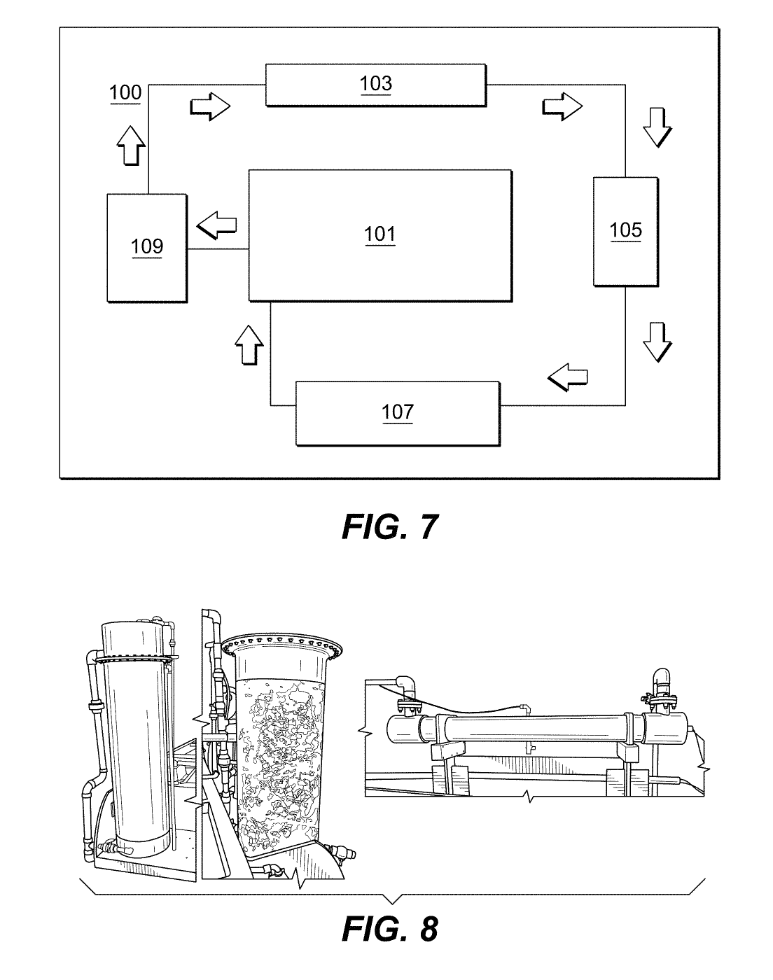

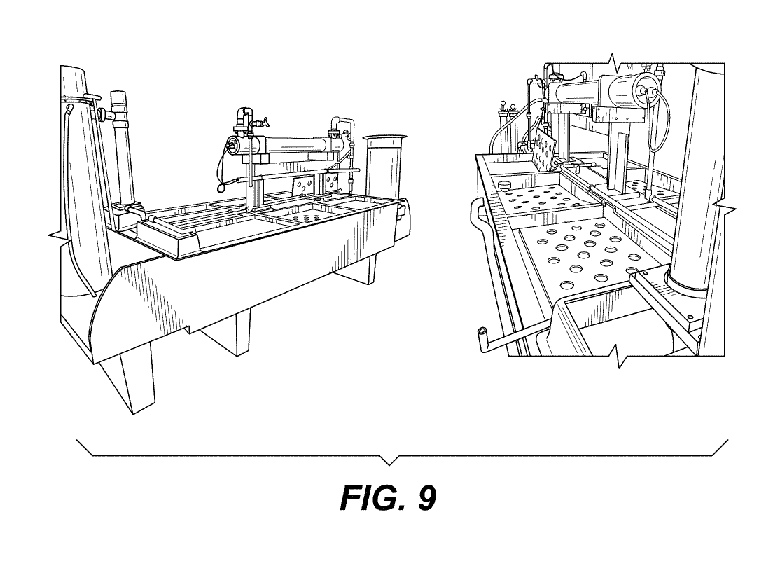

In certain embodiments, any suitable combination(s) of the holding tank 101, the water purifier 103, the fractionator 105, the oxygenator 107, and the filter 109 can be connected in fluidic series. For example, referring to FIG. 7, in certain embodiments, the holding tank 101, the water purifier 103, the fractionator 105, the oxygenator 107, and the filter 109 are all connected in fluidic series in a series order, e.g., such that a single closed loop is formed. The series order can be any suitable order and does not have to be as shown. FIG. 8 is a schematic view of embodiments of a fractionator, a bio filter, and UV filter. FIG. 9 is a schematic view of an embodiment of a system showing certain example placement and dimensions of various portions of the system 100.

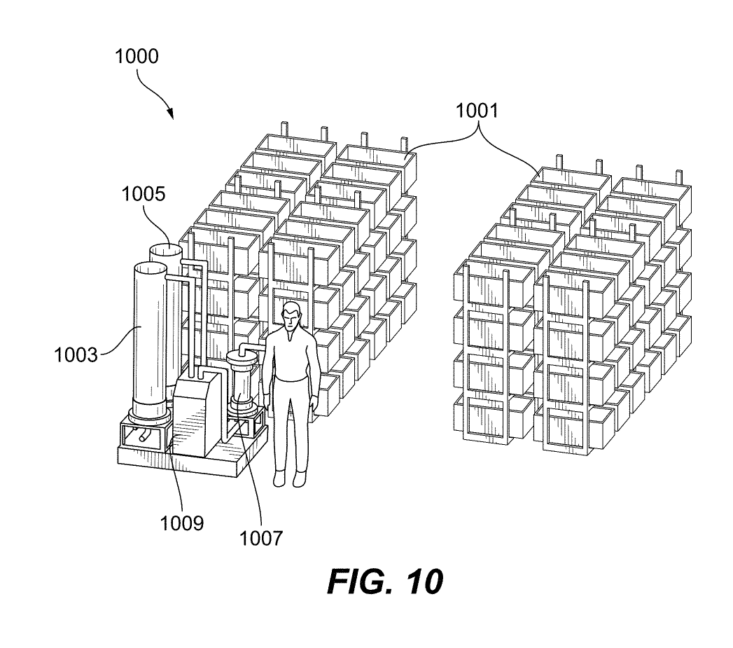

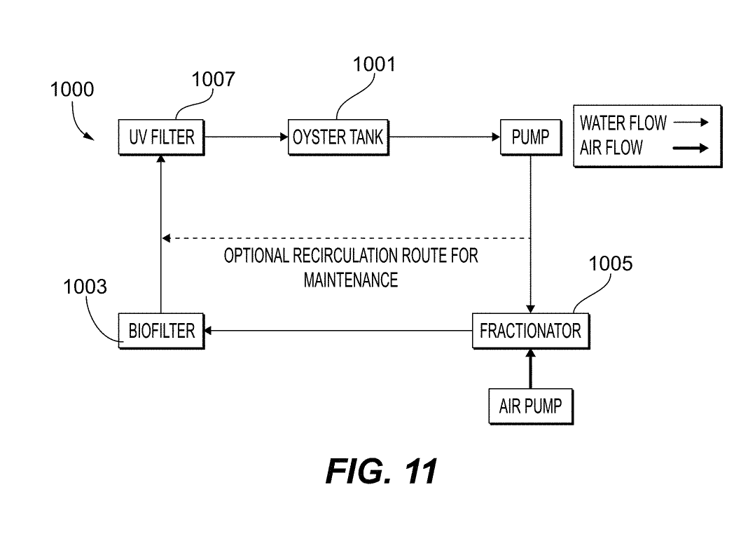

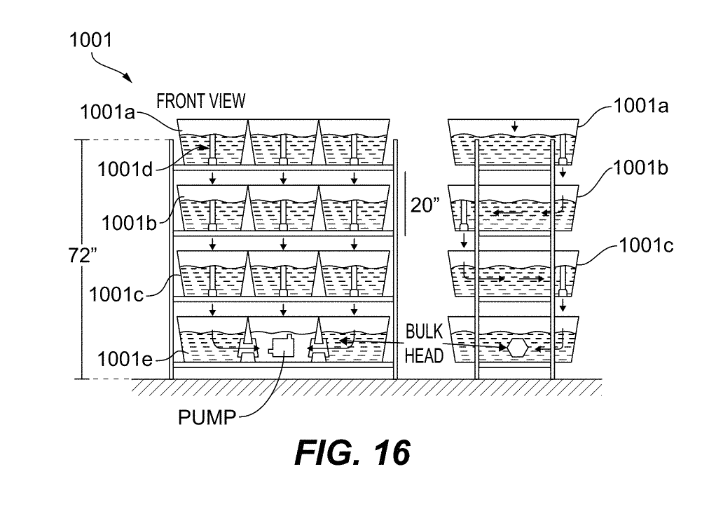

Referring to FIGS. 10 and 11, in accordance with at least one aspect of this disclosure, an embodiment of a live organism storage system 1000 can include a cascading holding tank 1001 configured to hold water and a plurality of live organisms. The cascading holding tank 1001 can be configured to cascade water from one or more top containers to one or more lower containers (e.g., as shown in FIGS. 15 and 16).

The system 1000 can include a water purifier 1003 in fluid communication with the holding tank 1001 and configured to purify water flowing therethrough. The system 1000 can include a fractionator 1005 in fluid communication with the holding tank 1001 that is configured to gather and remove protein and waste from water flowing therethrough. The system 1001 can include a filter 1007 in fluid communication with the holding tank 1001 and configured to filter water flowing therethrough.

The live organism storage system 1000 can be configured to be a closed loop system. In certain embodiments, the system 1000 can also include a temperature control device 1009 for controlling the temperature of water in the system 1000 (e.g., immediately upstream of the filter 1007). Also, any suitable pump can be included to circulate water through the system 100. In certain embodiments this temperature control device 1009 can include its own pump such that a standalone pump is not needed. The temperature control device 1009 can be any suitable heating/cooling system and can include any suitable dimensions (e.g., a commercially available 12″×19″×28″). Temperature range in certain embodiments can be between about 30 and about 250 degrees Fahrenheit, e.g., for flow rates over 30 gpm (e.g., between about 40 degrees F. and about 80 degrees F.). In certain embodiments, the system can include a temperature sensor and water cooling unit (e.g., a chiller) to regulate water temperature.

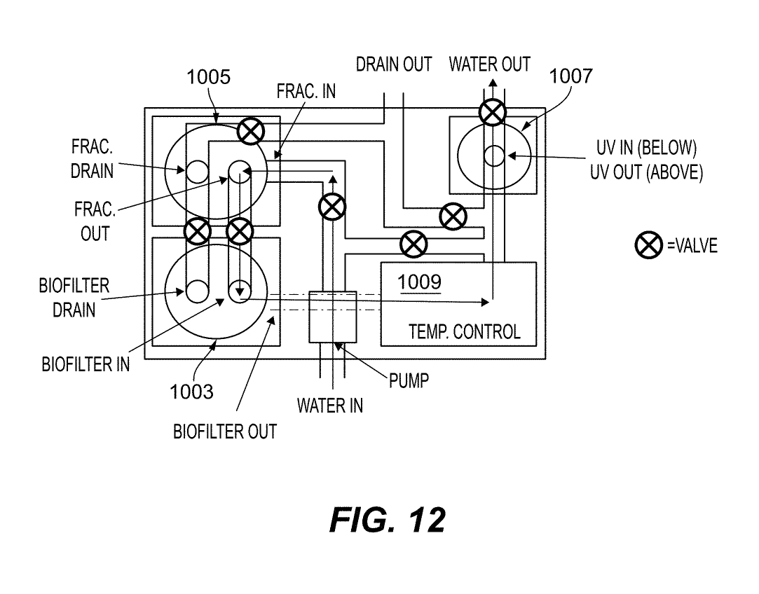

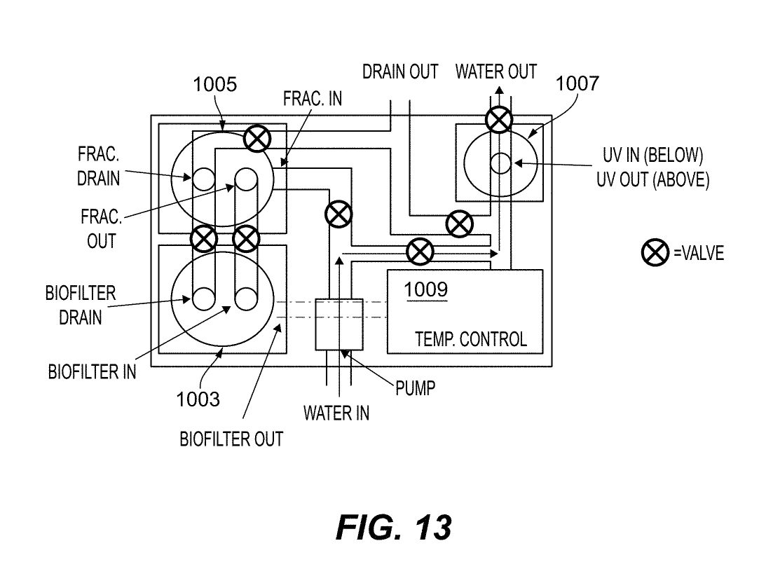

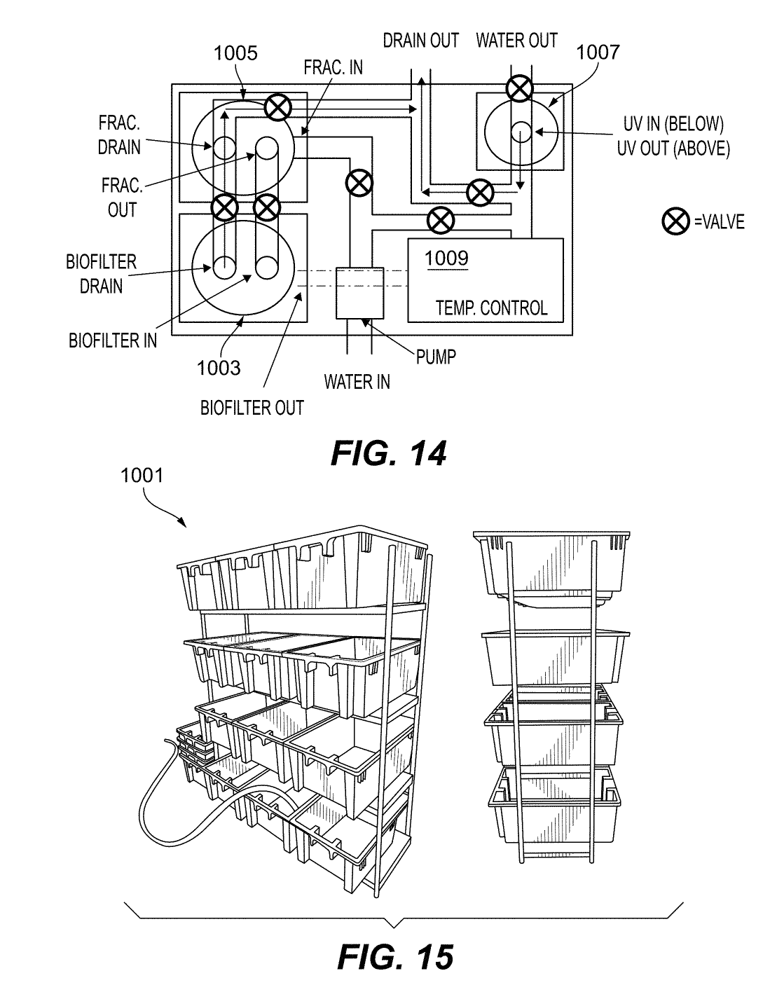

FIG. 12 shows a schematic diagram of an embodiment of piping of the system 1000, showing the system 1000 operating in a filtration loop (e.g., normal operation). As shown, water can flow from the holding tanks 1001 through the fractionator 1005, through the bio filter 1003, through the temperature control device 1009, through the filter 1007, and back to the holding tank 1001. FIG. 13 shows a schematic diagram of an embodiment of piping of the system 1000, showing the system 1000 operating in a UV only loop such that flow circulates from the holding tank 1001, through the filter 1007, and back to the holding tank 1001. FIG. 14 shows a schematic diagram of an embodiment of piping of the system 1000, showing the system 1000 operating in a drain state wherein at least one of (e.g., all of) the purifier 1003, the fractionator 1005, or the filter 1007 can be drained (e.g., to remove collected contaminants).

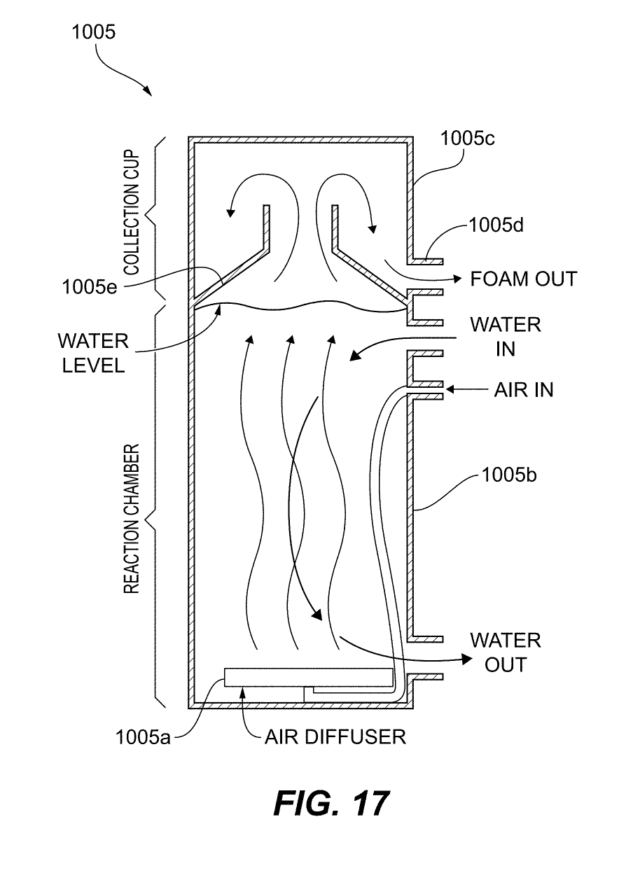

As shown in FIGS. 16 and 17, the cascade holding tank 1001 can include a plurality of containers 1001a, 1001b, 1001c, etc. in a stacked relationship and having a raised drain 1001d (e.g., a PVC insert and bulkhead) such that water will drain to a lower container 1001b, 1001c when water level in a higher container rises high enough. Each raised drain 1000d can be positioned longitudinally away from other raised drains 1000d to cause longitudinal flow in each container 1001a, b, c. A bottom container 1001e can be connected to the pump or to any other suitable part of the system 1000 to connect to the other components in the system 1000. As shown, in certain embodiments, a plurality of bottom containers 1001e can be connected together, e.g., through a bulk head such that water flows to a single location to be pumped. Any other suitable construction for the cascade tank 1001 is contemplated herein.

Referring to FIG. 17, the fractionator 1005 can be configured to extract unwanted proteins from water circulating through the system, e.g., by bombarding the water with fine air bubbles produced by an air diffuser 1005a in a reaction chamber 1005b. A foam head that forms at a top of the fractionator 1005 can accrue in a collection cup 1005c. The fractionator can include a fractionator drain 1005d to allow removal of the foam head from the collection cup 1005 from the fractionator 1005 (e.g., in the drain state).

The collection cup 1005c can include an inverted funnel 1005e to capture foam as shown. Any other suitable construction to remove foam is contemplated herein.

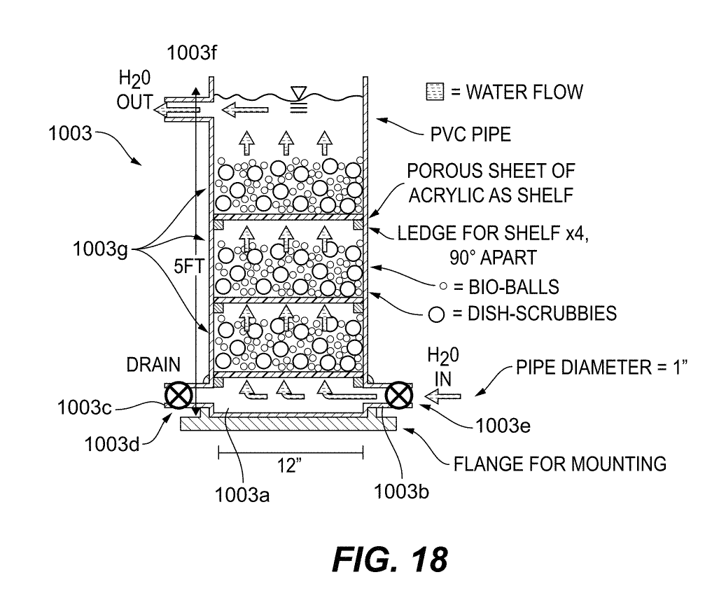

Referring to FIG. 18, in certain embodiments, the water purifier 1003 can be a bio filter. In certain embodiments, the bio filter 1003 can include a bottom manifold 1003a including a water inlet 1003b and a drain 1003c, each having a valve 1003d, e such that when the drain valve 1003d is closed and the water inlet valve 1003e is open, water can fill the bio filter 1003 in an upward direction as shown. The filter 1003 can include a water outlet 1003f above the bottom manifold 1003a to allow water to drain when suitably high (e.g., when it fills above a certain level). The filter 1003 can include one or more stages of filtration 1003g disposed between the bottom manifold 1003a and the water outlet 1003f. Each stage of filtration 1003g can include any suitable construction to act as a bio filter (e.g., including bio-balls, dish scrubbers, a porous sheet of acrylic delineating each stage, etc.).

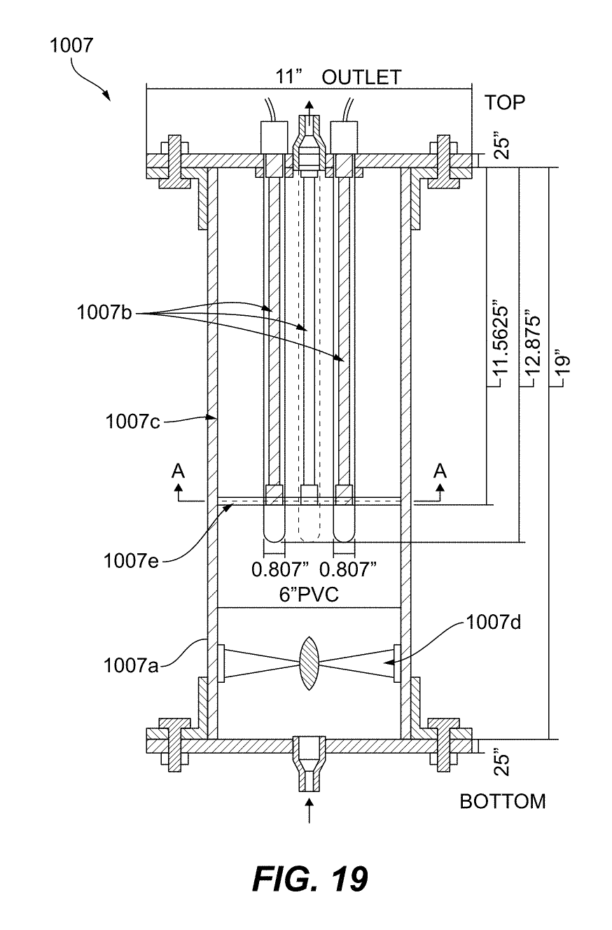

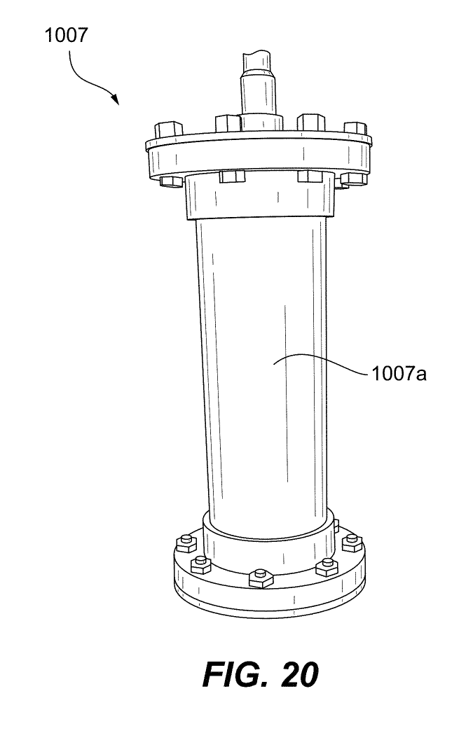

Referring to FIGS. 19 and 20, the filter 1007 can be a UV water treatment system, for example, and, in certain embodiments, the UV water treatment system can include a tubular UV water filter defining a tube shaped cavity 1007a. The UV filter can have three UV bulbs 1007b (or any other suitable amount) disposed therein, e.g., parallel with a long axis of the tube shaped cavity 1007a and extending at least partially down a length of the tube shaped cavity 1007a. The UV bulbs 1007b can be positioned 120 degrees apart from each other relative to a circumference of the tube shaped cavity 1007a.

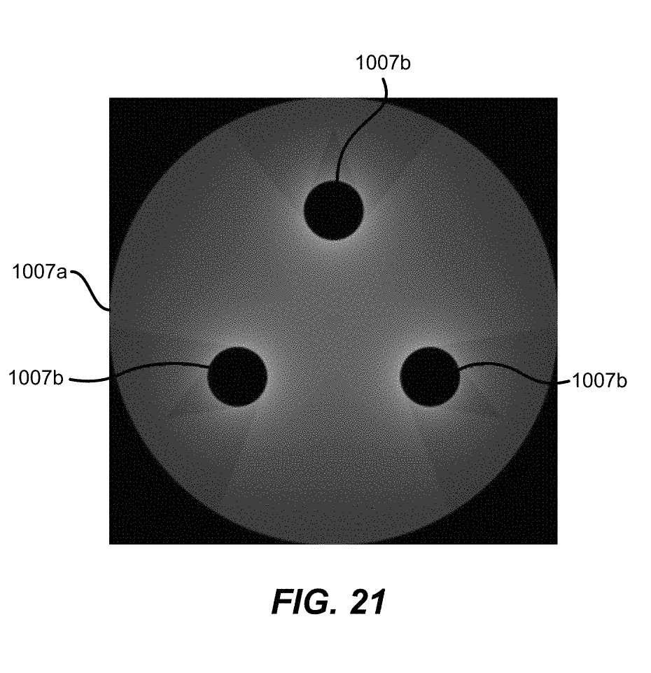

An embodiment of relative sizing and positioning between the tube shaped cavity 1007a and the bulbs 1007b is shown in FIG. 21. Also shown is a dosing profile, wherein lighter color is indicative of a higher dose of UV radiation in use. To enhance radiation, the tube shaped cavity 1007a can include a reflective liner or coating 1007c configured to reflect UV light, for example.

In certain embodiments, the UV water filter can include a stator mixer 1007d disposed within the tube shaped cavity 1007a and configured to mix water flowing to the UV bulbs 1007b. The UV water filter can include and a bulb stabilizer 1007e configured to hold the bulbs 1007b at an end thereof within the tube shaped cavity 1007a, for example. Any other suitable components or configuration to function as a UV filter is contemplated herein. In certain embodiments, flow in the UV filter can be bottom to top, however, any other suitable flow direction is contemplated herein.

Embodiments include a fractionator 1005 with increased water “dwell time” in the reaction chamber, increased airflow and air “dwell time” in the reaction chamber, and production of smaller bubbles (greater surface area to volume ratio) so more proteins can be removed. Embodiments of the fractionator extract unwanted proteins from the water circulating through the system, e.g., by “bombarding” the water with fine air bubbles (e.g., produced by an air diffuser or bubbler). This bombardment can occur in the reaction chamber, and a foam head forms at the top. This foam accrues in the collection cup, and then can be removed through a drainage system. Embodiments can include counter flow such that the water flow direction (downward) is against the air flow direction (e.g., bubbles moving upward).

In accordance with at least one aspect of this disclosure, a method includes providing flavored salt to water in a live organism storage system to cause the live organism to uptake a flavor. The live organism storage system can be an oyster storage system. In certain embodiments, providing the flavored salt includes adding flavored salt to the holding tank of the above described system. The process for infusing flavor into the water is done manually by mixing salt or other flavor enhancers with fresh water from a ground water well.

Embodiments includes benefits such as removal of nitrogen and depurate waste by the filter 109, elimination of all pathogens and microbes form water and oysters in the purification system, increased oxygen levels in the organisms to increase shelf life, removal of proteins and waste in the fractionator, and the oysters themselves are allowed to depurate and expel sediment from inside of their shell.

Embodiments provide availability of stock during times when new organisms cannot be harvested (e.g., bad weather, water quality closures of leased water column). Embodiments depurate and clean sediments and waste from inside of oysters. Embodiments can retain a consistent salinity level or otherwise allow control of salinity due to the closed loop, whereas harvested oyster salinity changes, e.g., due to water column area salinity changes from heavy rain or lack of rain. Embodiments allow flavoring to be added to the shellfish by using a flavored salt (e.g., garlic salt).

Testing has shown that embodiments described above can provide a safe raw oyster. Through testing by the Maryland Department of Health, it has been shown that the system has 0.0% pathogens and microbes after weeks of testing. The salinity level is kept constant in the closed loop system 100 and creates a year round consistency demanded by oyster consumers. Thus embodiments can provide both a consistent product and a safe product unlike existing systems and methods.

Embodiments, e.g., as shown in FIGS. 10-21, simplify piping, improve filtration, make it easier to sell and ship, and provide the ability to meet all FDA regulations, for example. Embodiments of a system (e.g., not necessarily including the containers of the cascade tank) are dimensioned to be a commercially saleable and shippable unit, e.g., that fits on a standard pallet for shipping. Embodiments improve spacing and functionality of bio filter, protein skimmer, and UV filter to make unit more compact and visually appealing. Certain embodiments can housing the oysters for up to about 2 to about 4 weeks, or longer. Embodiments can include an integrated sensor system and data logging for monitoring health and or quality of the live organism and/or the water and/or one or more system components. Certain embodiments can house about 7200 or more oysters per system.

Any suitable combination(s) of any disclosed embodiments and/or any suitable portion(s) thereof are contemplated herein as appreciated by those having ordinary skill in the art.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A live organism storage system, comprising:
a holding tank configured to hold water and a plurality of live organisms;
a water purifier in fluid communication with the holding tank and configured to purify water flowing therethrough;
a fractionator in fluid communication with the holding tank, the fractionator configured to gather and remove protein and waste from water flowing therethrough;
an oxygenator in fluid communication with the holding tank to increase oxygen content of water flowing therethrough; and
a filter in fluid communication with the holding tank and configured to filter water flowing therethrough,
wherein the live organism storage system is a closed loop system.

2. The system of claim 1, wherein the water purifier includes an ultraviolet (UV) water treatment system.

3. The system of claim 2, wherein the UV treatment system includes a horizontally mounted channel mounted over the holding tank to a wall of the holding tank.

4. The system of claim 1, wherein the fractionator includes a vertical chamber configured to fractionate water flowing therethrough.

5. The system of claim 1, wherein the filter includes a bio filter.

6. The system of claim 5, wherein the bio filter includes a chamber with biological material disposed therein.

7. The system of claim 6, wherein the biological material includes oysters and/or oyster shells.

8. The system of claim 1, wherein the filter is configured to remove nitrogen and/or depurate waste.

9. The system of claim 1, wherein at least one of the water purifier, the fractionator, the oxygenator, or the filter is in direct two-way fluidic communication with the holding tank.

10. The system of claim 1, wherein one or more combinations of the holding tank, the water purifier, the fractionator, the oxygenator, and the filter are connected in fluidic series.

11. The system of claim 10, wherein the holding tank, the water purifier, the fractionator, the oxygenator, and the filter are all connected in fluidic series in a series order.

12. A method, comprising:
providing flavored salt to a water in a live organism storage system to cause the live organism to uptake a flavor.

13. The system of claim 12, wherein the live organism storage system is an oyster storage system.

14. The method of claim 12, wherein providing the flavored salt includes adding flavored salt to the holding tank of the system of claim 1.

15. A live organism storage system, comprising:
a cascading holding tank configured to hold water and a plurality of live organisms;
a water purifier in fluid communication with the holding tank and configured to purify water flowing therethrough;
a fractionator in fluid communication with the holding tank, the fractionator configured to gather and remove protein and waste from water flowing therethrough; and
a filter in fluid communication with the holding tank and configured to filter water flowing therethrough,
wherein the live organism storage system is a closed loop system.

16. The system of claim 15, wherein the water purifier is a bio filter and the filter is a UV water treatment system.

17. The system of claim 16, wherein the fractionator is configured to extract unwanted proteins from water circulating through the system by bombarding the water with fine air bubbles produced by an air diffuser in a reaction chamber, and accruing a foam head that forms at a top of the fractionator in a collection cup, and to allow removal of the foam head from the collection cup through a fractionator drain.

18. The system of claim 16, wherein the bio filter includes:
a bottom manifold including a water inlet and a drain, each having a valve such that when the drain valve is closed and the water inlet valve is open, water can fill the bio filter in an upward direction;
a water outlet above the bottom manifold to allow water to drain when suitably high; and
one or more stages of filtration disposed between the bottom manifold and the water outlet.

19. The system of claim 16, wherein the UV water treatment system includes a tubular UV water filter defining a tube shaped cavity and having three UV bulbs disposed therein parallel with a long axis of the tube shaped cavity and extending at least partially down a length of the tube shaped cavity, wherein the UV bulbs are positioned 120 degrees apart from each other relative to a circumference of the water treatment system.

20. The system of claim 19, wherein the UV water filter includes a stator mixer disposed within the tube shaped cavity and configured to mix water flowing to the UV bulbs, and a bulb stabilizer configured to hold the bulbs at an end thereof within the tube shaped cavity.
